(19) United States
(12) Patent Application Publication
(10) Pub. No.: US 2018/0367778 A1
(43) Pub. Date: Dec. 20, 2018

(54) Method And Apparatus For Conversion Of HDR Signals

(71) Applicant: British Broadcasting Corporation, London (GB)

(72) Inventor: Timothy John Borer, Surrey (GB)

(21) Appl. No.: 15/548,825

(22) PCT Filed: Feb. 5, 2016
(86) PCT No.: PCT/GB2016/050272

§ 371 Date: Aug. 4, 2017

(30) Foreign Application Priority Data
Feb. 6, 2015 (GB) 1502016.7

(51) Int. Cl. H04N 11/20; H04N 9/77

(52) U.S. Cl. CPC H04N 11/20; H04N 9/77

(57) ABSTRACT

A method of processing a video signal from a higher dynamic range source having a source colour scheme to produce a signal usable by target devices of lower dynamic range having a target colour scheme used as a converter to implement a function. The function provides the received signal as a luminance component and separate colour components for each pixel and determines a maximum allowable luminance value for the colour components in the lower dynamic range scheme. A compression function is applied to the luminance component of each pixel. The compress luminance component and separate colour components are then provided as an output signal in the target colour scheme. The compression function depends upon the maximum allowable luminance value for the corresponding colour components of each pixel. In this way, the arrangement ensure no colours are distorted in the target lower dynamic range scheme.

### BACKGROUND OF THE INVENTION

This invention relates to processing a video signal from a source, to convert from a high dynamic range (HDR) to a signal usable by devices having a lower dynamic range.

High dynamic range (HDR) video is starting to become available. HDR video has a dynamic range, i.e. the ratio between the brightest and darkest parts of the image, of 10000:1 or more. Dynamic range is sometimes expressed as “stops” which is logarithm to the base 2 of the dynamic range. A dynamic range of 10000:1 therefore equates to 13.29 stops. The best modern cameras can capture a dynamic range of 13.5 stops and this is improving as technology develops.

Conventional televisions (and computer displays) have a restricted dynamic range of about 100:1. This is sometimes referred to as standard dynamic range (SDR).

HDR video provides a subjectively improved viewing experience. It is sometime described as an increased sense of “being there” or alternatively as providing a more “immersive” experience. For this reason many producers of video would like to produce HDR video rather than SDR video. Furthermore since the industry worldwide is moving to HDR video, productions are already being made with high dynamic range, so that they are more likely to retain their value in a future HDR world.

At present HDR video may be converted to SDR video through the process of “colour grading” or simply “grading”. This is a well-known process, of long heritage, in which the colour and tonality of the image is adjusted to create a consistent and pleasing look. Essentially this is a manual adjustment of the look of the video, similar in principle to using domestic photo processing software to change the look of still photographs. Professional commercial software packages are available to support colour grading. Grading is an import aspect of movie production and movies, which are produced in relatively high dynamic range, and are routinely graded to produce SDR versions for conventional video distribution. However the process of colour grading requires the use of a skilled operator, is time consuming and, therefore expensive. Furthermore it cannot be used on “live” broadcasts such as sports events.

HDR still images may be converted to SDR still images through the process of “tone mapping”. Conventional photographic prints have a similar, low, dynamic range to SDR video. There are many techniques in the literature for tone mapping still images. However these are primarily used, with user intervention in the same style as colour grading, to produce an artistically pleasing SDR image. There is no one accepted tone mapping algorithm than can be used automatically to generate an SDR image from an HDR one. Furthermore many tone mapping algorithms are computationally complex rendering them unsuitable for real time video processing.

Attempts have been made to adapt still image tone mapping algorithms for application to video. However these tend to suffer from a fundamental problem of inconsistency across time. Conventional still image tone mapping produce an image dependent mapping of the input HDR image to the output SDR image. Consequently the mapping changes according to the image content. This is unsuitable for video processing where it is necessary to maintain the same mapping for objects in a scene as they move, change orientation, move in and out of shadows and appear and disappear from the scene. Therefore for video processing a static, i.e. image independent, mapping is required. Conventional still image tone mapping algorithms do not provide such a static mapping of HDR to SDR.

Various attempts have been made to convert between HDR video signals and signals useable by devices using lower dynamic ranges (for simplicity referred to as standard dynamic range (SDR)). One such approach is to modify an opto electronic transfer function (OETF).

FIG. 1 shows an example system in which a modified OETF may be used to attempt to provide such conversion. An OETF is a function defining conversion of a brightness value from a camera to a “voltage” signal value for subsequent processing. For many years, a power law with exponent 0.5 (i.e. square root) has ubiquitously been used in cameras to convert from luminance to voltage. This opto-electronic transfer function (OETF) is defined in standard ITU Recommendation BT.709 (hereafter “Rec 709”) as:

$$V = \{ \begin{matrix}4.5 L & for 0 \leq L < 0.018 \\ 1.099 {L}^{0.45} - 0.099 & for 0.018 \leq L \leq 1\end{matrix}$$

where:

L is luminance of the image 0≤L≤1

V is the corresponding electrical signal Note that although the Rec 709 characteristic is defined in terms of the power 0.45, overall, including the linear portion of the characteristic, the characteristic is closely approximated by a pure power law with exponent 0.5.

Combined with a display gamma of 2.4 this gives an overall system gamma of 1.2. This deliberate overall system non-linearity is designed to compensate for the subjective effects of viewing pictures in a dark surround and at relatively low brightness. This compensation is sometimes known as “rendering intent”. The power law of approximately 0.5 is specified in Rec 709 and the display gamma of 2.4 is specified in ITU Recommendation BT.1886 (hereafter Rec 1886). Whilst the above processing performs well in many systems improvements are desirable for signals with extended dynamic range.

The arrangement shown in FIG. 1 comprises an HDR OETF 10 arranged to convert linear light from a scene into RGB signals. This will typically be provided in a camera. The RGB signals may be converted to YCbCr signals in a converter 12 for transmission and then converted from YCbCr back to RGB at converters 14 and 16 at a receiver. The RGB signals may then be provided to either an HDR display or SDR display. If the receiver is an HDR display then it will display the full dynamic range of the signal using the HDR EOTF 18 to accurately represent the original signal created by the HDR OETF. However, if the SDR display is used, the EOTF 20 within that display is unable to present the full dynamic range and so will necessarily provide some approximation to the appropriate luminance level for the upper luminance values of the signal. The way in which a standard dynamic range display approximates an HDR signal depends upon the relationship between the HDR OETF used at the transmitter side and the standard dynamic range EOTF used at the receiver side.

FIG. 2 shows various modifications to OETFs including the OETF of Rec 709 for comparison. These include a known “knee” arrangement favoured by camera makers who modify the OETF by adding a third section near white, by using a “knee”, to increase dynamic range and avoid clipping the signal. Also shown is a known “perceptual quantizer” arrangement. Lastly, a proposed arrangement using a curve that includes a power law portion and a log law portion is also shown. The way in which an SDR display using the matched Rec 709 EOTF represents images produced using one of the HDR OETF depends upon the OETF selected. In the example of the Knee function, the OETF is exactly the same as the Rec 709 for most of the curve and any departs therefrom for upper luminance values. The effect for upper luminance values at an SDR receiver will be some inaccuracy.

FIG. 3 summarises the impact of a modified HDR OETF on the signals provided to a standard dynamic range receiver. Each of the RGB HDR signals is effectively compressed by a compressor 30 to produce SDR RGB signals.

### SUMMARY OF THE INVENTION

We have appreciated that the dynamic range of the video signal may be increased by using alternative OETFs such as those mentioned, or other OETF, but that this can cause consequential problems in relation to other qualities of the video signal. We have further appreciated the need to maintain usability of video signals produced by HDR devices with equipment having lower than HDR dynamic range. We have further appreciated the need to avoid undesired colour changes when processing an HDR signal to provide usability with existing standards.

The invention is defined in the claims to which reference is directed.

In broad terms, the invention provides conversion of a video signal from a high dynamic range source to produce a signal usable by devices of a lower dynamic range involving a function that compresses a luminance components in a manner that depends upon the maximum allowable luminance for the lower dynamic range scheme for the corresponding colour component of each pixel.

An embodiment of the invention provides advantages as follows. The separation into luminance and colour components prior to compression of luminance ensures that relative amounts of colour as represented in the source signals (such as RGB) do not alter as a result of the compression. This ensures that colours are not altered by the processing.

The use of a compression function that depends upon the maximum allowable luminance for the lower dynamic range scheme for the corresponding colour, that is the ratios of the colour components, of each pixel ensures that a given luminance value for a colour in the source signal may be modified in such a manner that it is chosen not to exceed (and therefore hard clip) that which is possible in the target scheme.

The dependence on the maximum allowable brightness is preferably that the compression function has a maximum output for a given colour that is the maximum luminance output for that colour in the target scheme. This allows the full range of the target scheme to be used whilst ensuring that the brightness of all colours is altered appropriately to avoid perceptible colour shifts.

The compression function applied to the luminance component of each pixel is reversible in the sense that each output value may be converted back to a unique input value. This allows a target device that is capable of delivering HDR to operate a reverse process (decompression) so that the full HDR range is delivered. This reversibility may be achieved by use of a curve function that has a continuous positive non zero gradient between the black and white points.

The compression applied to the luminance components may be provided as a single process or separated into a compression function and a limiting function. The compression function in such an arrangement may generate values outside the legal range of the target scheme. Accordingly, the limiting function serves the purpose of ensuring output signals remain within a legal range of the target scheme. Example compression functions include power laws, log functions or combinations of these with a linear portion. Preferably, the limiting function includes a linear portion for lower luminance values and log portion for higher luminance values. This ensures that darker parts of a scene are unaltered by the process, but brighter parts of a scene are modified so as to bring the luminance values into a tolerable dynamic range without altering colours.

The conversion function may be implemented using dedicated hardware components for each of the processing steps, but preferably the conversion function is implemented using a three dimensional look up table (3D-LUT). Such a 3D-LUT may be pre-populated using calculations according to the invention such that an input signal comprising separate components may be converted to an output signal of separate components, but in which each of the output components is a function of all three input components. This is the nature of a 3D-LUT. The conversion function may also be implemented as separate modules. Such separate modules may themselves comprise look up tables.

One implementation of the limiting function is preferably as a two dimensional look up table (2D-LUT), such a two dimensional look up table would comprise the two dimensions of colour space to provide an output value that is the maximum luminance for each such colour on the two dimensional colour space. Further aspects may also be implemented as look up tables, for example the compression function may be a one dimensional look up table applied prior to the two dimensional limiting function.

Alternatively, the individual parts of the HDR to SDR conversion may be implemented arithmetically, e.g. with floating point inputs. The preferred implementation of the components would be as LUTs, where the bit depth is sufficiently small to permit this. As already noted, overall the components may be subsumed into a single 3D LUT which is the preferred implementation.

### BRIEF DESCRIPTION OF THE DRAWINGS

The invention will be described in more detail by way of example with reference to the accompanying drawings, in which:

FIG. 1 is a diagram of an arrangement in which a modified OETF may be used to modify an HDR signal for use with SDR target equipment;

FIG. 2 is a graph showing a comparison of opto electronic transfer functions;

FIG. 3 is a diagram showing conceptually the operation of the arrangement of FIGS. 1 and 2 applying a compression function to each R, G, B channel;

FIG. 4 is a diagram of an arrangement embodying the invention;

FIG. 5 is a diagram of an alternative arrangement embodying the invention;

FIG. 6 shows the functional components of the pre-processing module according to a first variation;

FIG. 6A shows the functional components of a pre-processing module according to a second variation in which additional system gamma is applied;

FIG. 6B shows the functional components of a pre-processing module according to a third variation in which an additional non-linearity is applied;

FIG. 7 is a schematic diagram of a compression function implemented by a compressor;

FIG. 7A is a diagram showing a limiter function applied by the limiter;

FIG. 8 shows a decompression function applied by a decompressor;

FIG. 8A shows a delimiter function applied by a delimiter;

FIG. 9 shows the overall effect of applying compression and system gamma in the variation of FIG. 6A or 6B;

FIG. 10 shows the functional components of the pre-processing module according to a second embodiment;

FIG. 11 shows an additional colour compressor module that may be used with the arrangement of FIG. 6, 6A, 6B or 10; and

FIG. 12 shows schematically the arrangement of colour spaces to which the colour compressor of FIG. 11 may be applied.

### DESCRIPTION OF A PREFERRED EMBODIMENT OF THE INVENTION

The invention may be embodied in a method of processing video signals to convert between higher dynamic range and lower dynamic range compatible signals, devices for performing such conversion, transmitters, receivers and systems involving such conversion.

An embodiment of the invention will be described in relation to a processing step which may be embodied in a component within a broadcast chain. The component may be referred to as a pre-processor for ease of discussion, but it is to be understood as a functional module that may be implemented in hardware or software within another device or as a standalone component. A corresponding post-processor may be used later in the broadcast chain such as within a receiver or within an HDR display. In both cases, the function may be implemented as a 3D look up table. Some background relating to HDR video will be repeated for ease of reference.

An embodiment of the invention addresses two impediments to the wider adoption of high dynamic range (HDR) video. Firstly it is necessary to convert HDR video to signals recognisable as standard dynamic range (SDR) so that they may be distributed via conventional video channels using conventional video technology. Secondly a video format is needed that will allow video to be produced using existing infrastructure, video processing algorithms, and working practices. To address both these requirements, and others, it is necessary to convert HDR video into SDR video algorithmically, hence allowing automatic conversion.

A key difference between HDR images and SDR images is that the former support much brighter “highlights”. Highlights are bright parts of the image, such as specular reflections from objects, e.g. the image of the sun reflected in a chrome car bumper (automobile fender). In converting from HDR to SDR, for example during grading, a key process is to “compress” the highlights. That is the amplitude of the highlights reduced while minimising the effect on the rest of the image. So the embodiment provides for the automatic reduction in the amplitude of image highlights.

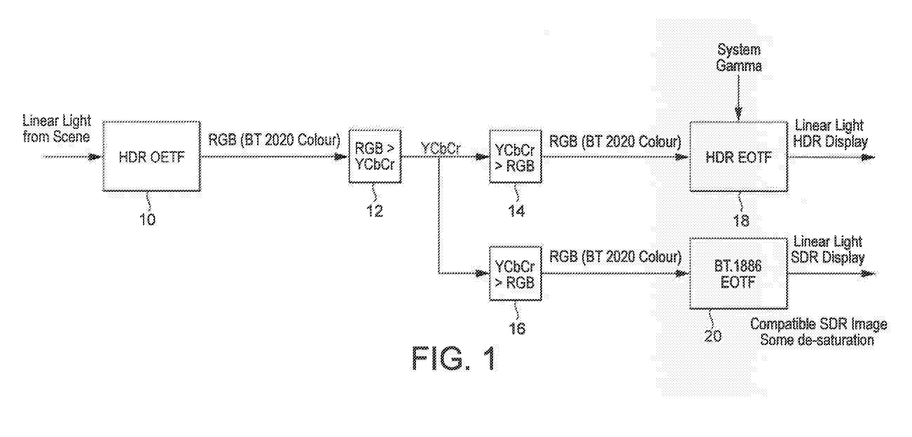

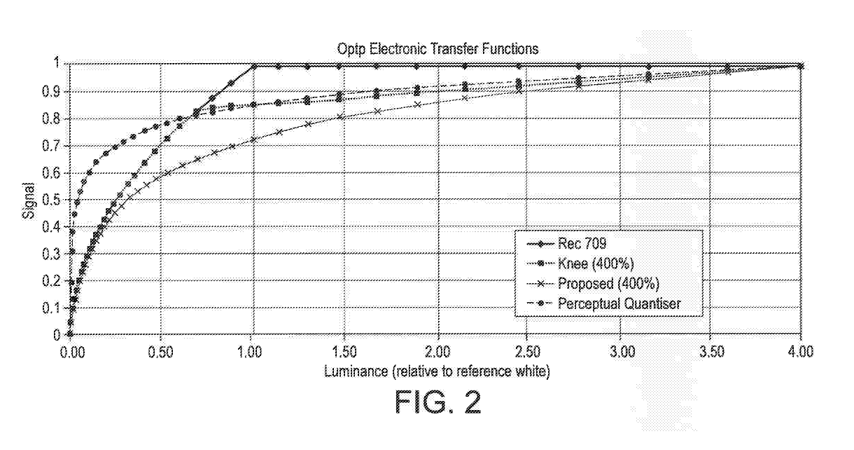

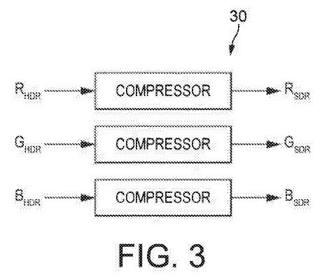

One way to reduce the dynamic range of an image is to apply a compressive, non-linear transfer function to each of the colour components (RGB) of the image. This is the situation of known arrangements as shown in the arrangement of FIG. 1 if using an OETF of the type shown in FIG. 2 or other OETF providing a compression function on each component as shown in FIG. 3.

A compressive transfer function is a “convex” function, which in this context means a function in which the gradient decreases as the input argument increases. Furthermore such a compressive function should be strictly positive for positive arguments (because light amplitude, i.e. luminance, is strictly positive, you can't have negative photons). So an example of a compressive function might be: output=natural logarithm(input+1.0).

Examples of compressive functions are those already shown in FIG. 2.

Unfortunately simply applying a compressive function to each of the colour components in the manner of FIGS. 1 and 2 changes their relative amplitudes and, consequently, changes the colour. The most significant effect would be to “de-saturate” bright colours, i.e. to make bright colours less intense.

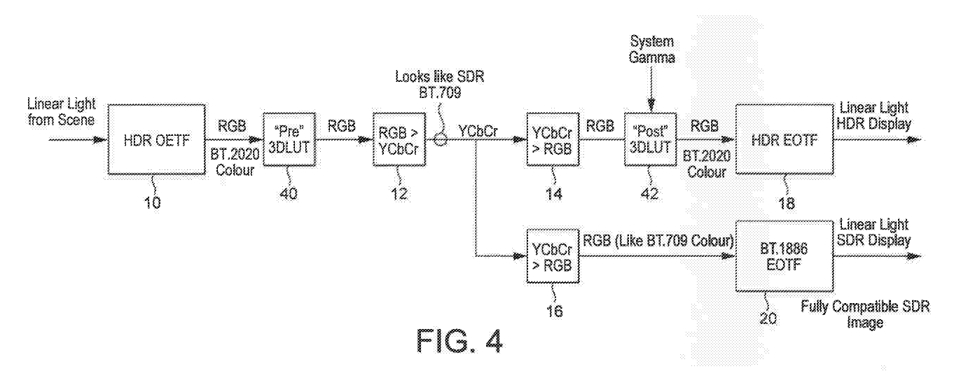

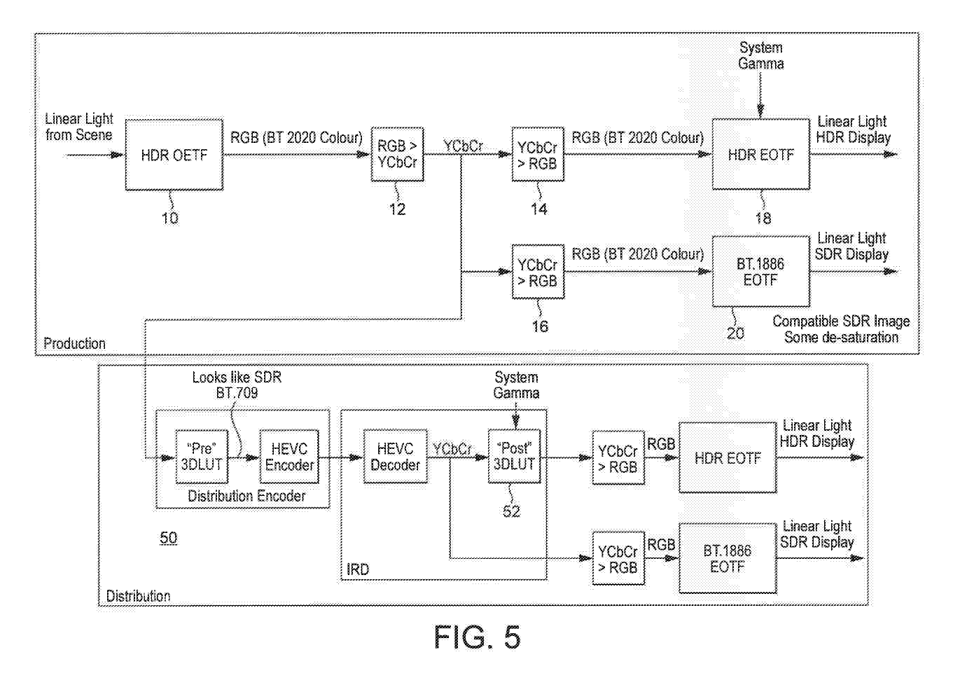

FIGS. 4 and 5 show embodiments of the invention which provide an additional processing stage which we will refer to as a pre-processor 40 (FIG. 4) and pre-processor 50 (FIG. 5) whose purpose is to provide a compressive function in such a manner that luminance levels are appropriately altered to allow a display of one, lower dynamic range, (such as an SDR display) to display signals originating in another, higher dynamic range, (such as HDR signals) without the de-saturating effect nor other minor colour distortions. The difference between the arrangements of FIGS. 4 and 5 is simply the position in the production and distribution chain in which the pre-processing module is provided. The invention may be applied to signals of any source format such as RGB, YCbCr or other format, but for simplicity the embodiment will be described primarily in relation to RGB.

The embodiment provides a static mapping from HDR video to SDR video, that is one in which the mapping is independent of picture content. Furthermore it may be implemented using simple hardware, a 3D lookup table (LUT) to implement the pre-processor or post-processor, such 3D-LUTs being already present in a high proportion of video displays. 3D LUTs may also be purchased, at low cost, for professional video (i.e. using conventional serial digital interfaces (SDI)). The embodiment implements a conversion of HDR video to SDR compatible video independently of the scene content. It also provides a complementary restoration of the SDR compatible video produced from an HDR original back to HDR. That is the conversion is reversible.

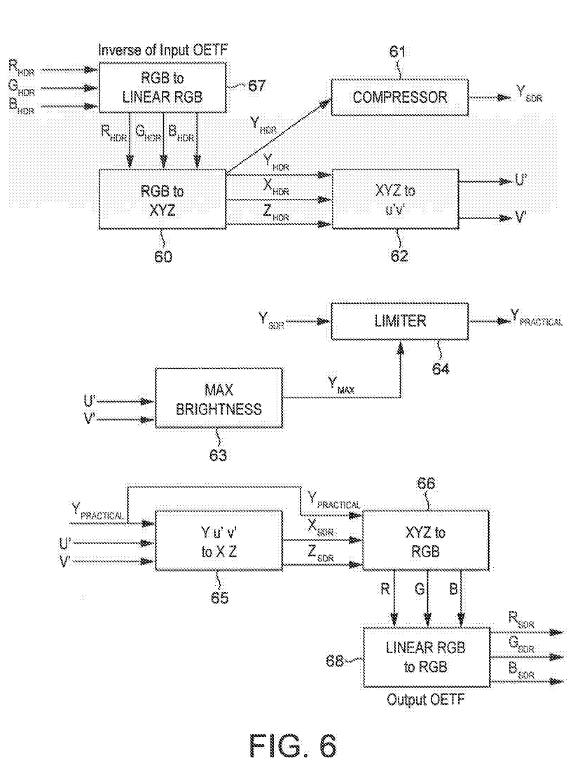

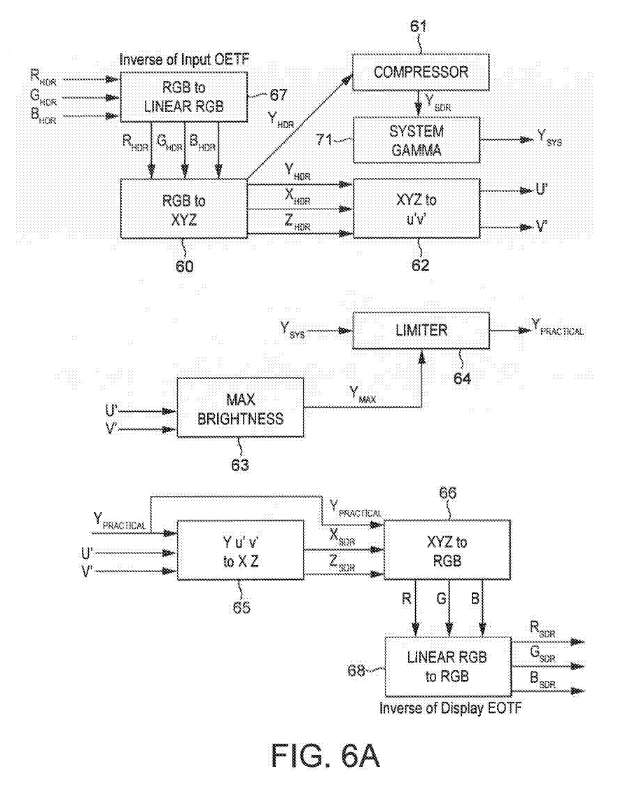

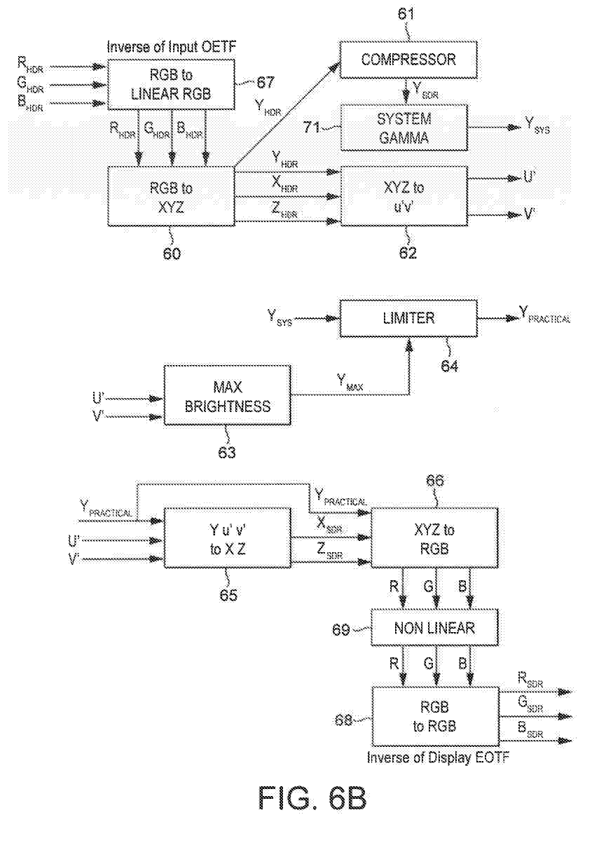

The overall process will first be described in relation to FIGS. 4 and 5 to provide an understanding of the end-to-end processing. Subsequently, the functional modules identified as the pre-processor 40 and post-processor 42 will be described in relation to FIGS. 6, 6A and 6B. It is repeated, for the avoidance of doubt, that the pre-processor and post-processor modules may be implemented as separate functional components as shown in FIGS. 6, 6A and 6B or may equally be applied as a software routine, 3D-LUT or other implementation.

We will first describe the arrangement shown in FIG. 4. Like components are numbered in the same manner as in FIG. 1. An input signal, here an RGB signal, is provided from a source that uses an HDR OETF 10 derived from linear light from a scene. Linear light is directly proportional to the number of photons received, hence the use of the word “linear”. The HDR OETF 10 may be considered to be a camera or any other source of signals such as RGB derived using an appropriate OETF, preferably the proposed OETF shown in FIG. 2. An additional component referred to as a pre-processor 40 provides conversion of the HDR RGB signal for transmission to receivers that allows the signal to be viewed on SDR receivers whilst retaining the dynamic range thus also allowing the original HDR RGB signal to be viewed correctly on HDR displays. The pre-processor is discussed in detail later.

An RGB to YCbCr converter 12 and corresponding converters 14 and 16 to convert back to RGB may be provided as part of a transmission channel. A standard definition display 20 contains an EOTF function such as Rec 1886 corresponding to Rec 709 which is capable of rendering an appropriate representation of the original HDR signal on the SDR display. It is the use of the pre-processor 40 that ensures an appropriate image is displayable. If the receiver has an HDR display 18 having an appropriate corresponding HDR EOTF, a post-processor 42 is provided to reverse the processing undertaken in the pre-processor 40 to recover the original RGB HDR signal to take advantage of the full dynamic range for display.

Some particular features of the arrangement of FIG. 4 will be noted now for ease of future reference. The input to the pre-processor 40 is a signal, such as RGB, from an HDR device. This is a signal in which each component has a “voltage” in the range 0 to 1. The output of the pre-processor 40 looks like an RGB signal that has been provided according to the Rec 709 OETF. This is why it can be correctly viewed on an SDR display. However, this signal is actually still a full HDR signal and no information has been lost, it is simply a different signal in RGB format with each component having a “voltage” in the range 0 to 1. As shown on FIG. 4, therefore, the signal “looks like SDR Rec 709”. This is why an SDR display 20 may use the Rec 1886 EOTF as this corresponds to the Rec 709 OETF. In order to reverse the process provided by the pre-processor 40, the post-processor 42 is used prior to an HDR display so as to retrieve the full range of the original HDR signal and provide this to the HDR display. Optionally, the colour space may also be converted between Recommendation BT. 2020 (hereafter Rec 2020) and Rec 709 in the path to the SDR display as discussed later.

FIG. 5 shows an alternative embodiment comprising the same components as in FIG. 4, but with the pre-processor 50 and post-processor 52 shown at different points in the broadcast chain. In the production environment shown by the components in the upper part of FIG. 5, no pre-processing is applied since it is likely that a production team will be working using full HDR compatible equipment. Prior to distribution, though, a pre-processor receives the signals from a point in the production chain, here shown as the YCbCr signals and provides pre-processing within a distribution encoder. At a high dynamic range receiver a post-processor 52 is provided. Within a standard dynamic range receiver, no such post-processor is provided but the signal is viewable on the display as previously described. The input and output for to the-processor (3D-LUT) in FIG. 5 is YCbCr rather than RGB. These are alternative colour components which may be processed as previously described. In a 3D-LUT implementation the LUT will have different values depending upon the source and/or target format.

The pre-processor 40 (FIG. 4) and 50 (FIG. 5) will now be described in detail as shown in FIGS. 6, 6A and 6B. As already noted, these may each comprise a 3D-LUT, but the separate functional blocks are described for clarity.

FIG. 6 shows an embodiment of the invention that recognises that, to avoid desaturation of bright colours, the compressive function should be applied to the brightness component of the image only, whilst leaving, as far as possible, the colours unchanged. This can be achieved by converting the input signal such as in RGB, YCbCr or other format into a subjective colour space that separates the brightness and colour aspects of the image. A suitable colour space is Yu′v′, which is strongly related to the CIE 1976 L*u*v* colour space. The Y component in Yu′v′ is simply the Y component from CIE 1931 XYZ colour space, from which L* is derived in CIE 1976 L*u*v*. The u′v′ components, which represent colour information independent of brightness, are simply the u′ & v′ components defined in CIE 1976 L*u*v* as part of the conversion from CIE 1931 XYZ. Other similar colour spaces are known in the literature and might also be used in this invention.

FIG. 6 shows the main functional components of the pre-processor 40, 50 which takes as an input a signal such as RGB that has been provided using an HDR OETF and provides as an output a signal such as RGB capable of being viewed on an SDR display or which can be processed using a reverse process to generate a full HDR signal for presentation on an HDR display. The received RGB signal may have been provided using any appropriate HDR OETF, but preferably uses the proposed OETF of FIG. 2. The pre-processor either implements the steps described below, or may provide an equivalent to those steps in a single process, such as a 3D-LUT.

In order to convert the input RGB to Yu′v′ the signal is converted to the CIE 1931 XYZ. Because the input signal is derived from linear light via an OETF (non-linear) the RGB components are first transformed back to linear using the inverse of the OETF in RGB to linear module 67. The conversion to XYZ may then simply be performed, as is well known in the literature, by pre-multiplying the RGB components (as a vector) by a 3×3 conversion matrix. The RGB to XYZ converter 60 receives the linear RGB signals and converts to XYZ format. At this stage, the XYZ signals represent the full dynamic range of linear RGB HDR signals. An XYZ to u′v′ converter 62 receives the XYZ signals and provides an output in u′v′ colour space. Separately the luminance component Y is provided to a compressor 61 which provides a function to compress (also known as compand) the signal to reduce the range. Compression is used in the sense of a compressive function previously described. This may also be referred to companding. The companding applied may be similar to the “Knee” function shown in FIG. 2. At this stage, the output to the compressor 61 and XYZ to u′v′ converter 62 comprises Y u′ v′ signals in which the luminance of pixels has been companded.

The luminance component Y may be further modified to allow for viewing conditions such as by adding a black offset and applying a system gamma (described later). Such modifications to the luminance Y are applied to that luminance rather than separately to the RGB components as previously described to avoid changing colour saturation.

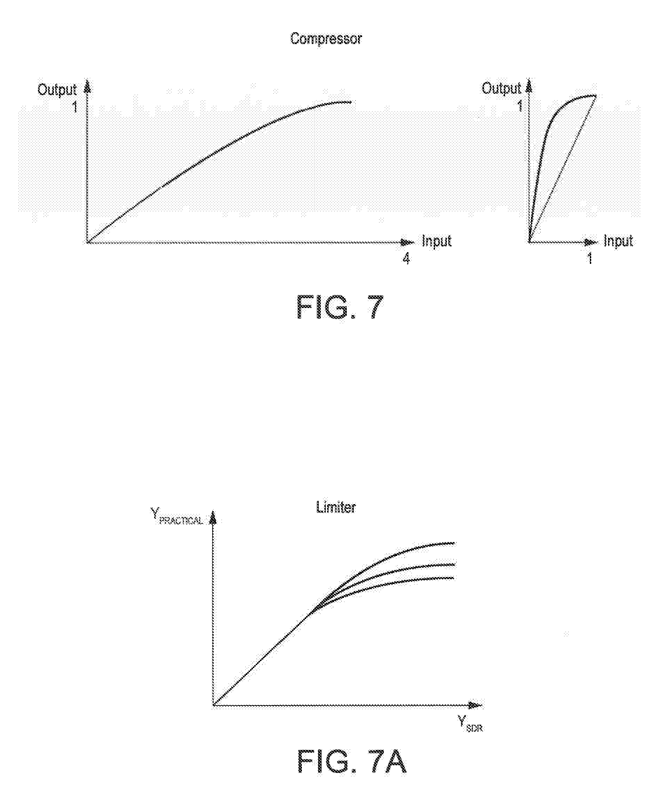

A compression function of the type applied by the compressor module 61 is shown in FIG. 7. As shown in the left-hand portion of FIG. 7 an input in the range 0 to 4 is compressed using a compression curve of the type already described to provide an output in the range 0 to 1. The right-hand side of FIG. 7 shows the same arrangement but with the input range normalised to be 0 to 1. This makes clear an effect of the compression, namely that values are increased relative to their input in the process of bringing all values to be within the output range.

The effect of the modifications may be to generate values that are outside the legal range 0 to 1 of RGB when the signal is converted back to RGB format. Accordingly, the luminance component is soft clipped to ensure the final RGB signal remains within its legal range. Referring back to FIG. 6 to provide this soft clipping a max brightness function 63 receives the u′ and v′ components and asserts a signal Y_{MAX} that defines for each combination of u′ v′ values the maximum allowable luminance value for the colour components when provided in the lower dynamic range scheme. Y_{MAX} is the maximum possible value of Y for a given colour co-ordinate u′v′ such that when Yu′v′ is converted to RGB in the target/output colour space each of RGB are less than or equal 1.0. Accordingly, Ymax is the maximum value of Y which guarantees that, following processing, clipping of RGB components is not required to ensure that they are in the permitted output range of [0:1]. An example calculation for Y_{MAX} is given in Appendix A.

Y_{MAX} is provided to a limiter function 64 which receives the luminance component of the signal and, for each pixel, limits the luminance component based on the colour of that component to provide an output signal Y_{PRACTICAL}.

The limiter function is conceptually shown in FIG. 7A. For an input value Y_{SDR} it is desired to provide an output value Y_{PRACTICAL} such that, when converted back to RGB, the RGB signal does not violate the voltage range 0 to 1. The limiter function depends upon the particular colour and so FIG. 7A shows differing curves that may be used for differing colours. Functionally, the limiter selects an appropriate limiting curve from the available curves depending upon the colour of a given pixel. For example, a strongly coloured blue pixel may require more limiting than a strongly coloured red pixel. Accordingly, the limiter will select the lower of the curves for the blue pixel and the upper of the curves for the red pixel. For the avoidance of doubt, there would conceptually be as many curves as there are colours in the u′ v′ colour space. This can be implemented as a two dimensional look up table or computationally or indeed as part of one large 3D look up table as previously mentioned.

Referring back to FIG. 6 again the modified luminance component Y_{PRACTICAL} and u′ v′ are then converted back to RGB signals via a Y u′ v′ to XZ converter 65 and an XYZ to RGB converter 66 providing an output signal RGB. This is a linear RGB signal and so is then converted to a “gamma corrected” non-linear format using an OETF 68 for the display so that it is displayable on an SDR display. The OETF module 68 implements an appropriate OETF depending upon the target SDR arrangement. It should be recalled that the purpose of the pre-processor shown in FIG. 6 is to provide a signal that is close to a familiar Rec 709 SDR signal. Accordingly, the preferred OETF implemented in the linear to RGB OETF converter 68 is indeed the Rec 709 OETF. Taken overall, the pre-processor shown in FIG. 6 has received an HDR signal provided from a camera that used an HDR OETF, applied an inverse of that OETF and then the subsequent processing steps described above and then at the output applied a Rec 709 OETF for an SDR display. The signal is therefore similar at the output as would have been provided from a SDR camera using a Rec 709 OETF, but importantly the signal still contains the full information that was provided by the HDR camera.

At an SDR receiver, the RGB signals may be used directly using a Rec 1886 EOTF. At an HDR receiver, the inverse of the process of FIG. 6 is applied. This is discussed in detail later, but briefly operates an inverse of each of the steps of FIG. 6 to convert back to an HDR signal. The HDR display may perform additional processing to make the HDR image look subjectively correct. The light output is not, usually, directly proportional to the input light because the display brightness and the viewing environment (primarily the background illumination) are not the same as at the camera. These may be allowed for in the display (discussed later).

The compatibility of the RGB output from the pre-processor may be understood by referring back again to FIG. 4. Consider first the path from camera 10 containing an HDR OETF to an HDR display containing HDR EOTF 18. In the signal path a pre-processor 40 implementing the process described in relation to FIG. 6 is provided and a post-processor providing the reverse of that process shown in FIG. 6 is provided. The appearance on the HDR display therefore depends upon the interplay between the original HDR OETF and the display EOTF. If the EOTF is chosen to be an exact inverse of the OETF, then the HDR display will produce a linear light output. As previously mentioned, though, current systems choose to have an overall “system gamma” of 1.2 due to various factors such as human perception of brightness and colour. Accordingly, the HDR EOTF at display 18 may be chosen not to be an exact inverse of the HDR OETF at source 10. In which case, the end-to-end path will have an overall “system gamma” also referred to as “display adjustment” or “rendering intent”.

The path from the HDR camera to a SDR display will now be considered. Recall that the RGB signal provided from the HDR device 10 has been provided according to a particular OETF. The first stage of the pre-processor reversed the camera OETF to generate linear RGB and then the luminance component. The luminance values could go beyond those displayable on an SDR display and so the soft clipping provided by the compressive limiter function ensures the final RGB signal remains within its legal range and conceptually modifies the luminance component such that it falls within an allowable range 0 to 1 for an SDR display, but without particular modification to the shape of the signal versus luminance curve. At the output, a Rec 709 OETF is used the signal provided looks to a receiver like SDR Rec 709 and can be displayed at the receiver using a normal SDR EOTF.

The choice of OETF does not particularly impact the operation of an embodiment of the invention because whatever the input, the first step is effectively conversion to linear light (i.e. no OETF) and with sufficient precision (i.e. enough bits) to avoid artefacts. This is, potentially, a practical scenario because the embodiment might be used with the OpenEXR format, which is a 16 bit floating point format that (usually) stores linear light. Other floating point formats might also be used. One implementation would be to use a 3D LUT to perform the processing. The problem with this is, again, the number of bits required on the input for linear light with an HDR signal (minimum 16 bits for linear light HDR signal). We would get round this by using a nonlinear compressive function on each channel (RGB) prior to inputting the signal into the 3D LUT. So you might have a 16 bit linear signal, through a 1D LUT, reduced to 10 bits. We can have a LUT because it is only 1 dimensional, or there would be other, simple, ways to implement this compressive non-linearity prior to the 3D LUT. The proposed OETF as shown in FIG. 2 would be quite suitable to reduce the number of bits prior to a 3D LUT. But other, compressive, OETFs would also be satisfactory.

The concept of the embodiment is not strongly coupled to the choice of OETF; the arrangement may operate with any OETF that encodes HDR into a limited number of bits (e.g. 10 bits). A key point is that the simplest LUT implementation would need RGB linear light passed through (3) 1D LUTs and then the 3 reduced bit depth signals processed in a 3D LUT. Both the 1D LUTs and the 3D LUT might reasonably be implemented in the camera.

FIGS. 6A and 6B show variations of an embodiment of the invention. These variations may be implemented as separate functional modules or as a 3D-LUT as previously described. Like components use the same numbering and so the description of the components using the same numbering is as previously described and will not be repeated here.

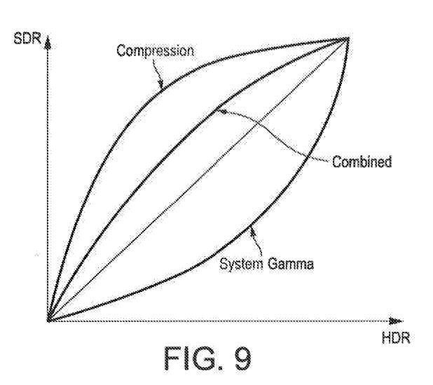

FIG. 6A provides an additional component referred to as a system gamma module 71. This module is provided in the luminance path between the compressor module 61 and the limiter module 64 and may be provided to alter the overall end-to-end “gamma” of the system from acquisition to rendering on a display. This block may functionally provide a system gamma of value 1.2 to the luminance component, namely a simple one dimensional look up that provides conversion of the input Y_{SDR} by a power function of 1.2 to produce an output Y_{SYS}. Other values could be chosen. Providing the desired overall system gamma at this point has a number of advantages. First, as the processing by the whole pre-processing module is already considering luminance as a separate component, this is a convenient point in the system to apply the system gamma. It should be noted that as a consequence of applying the system gamma at this point, the linear RGB to RGB conversion module 68 applied an inverse of the display EOTF rather than the OETF for SDR as in FIG. 6. This is because a standard dynamic range of display will itself apply an EOTF that inherently includes the system gamma. By explicitly applying the system gamma within the pre-processor, the output from the pre-processor must therefore use an inverse of the display EOTF for the correct display on a standard dynamic range display. A second advantage of providing the system gamma at this point relates to the relationship between the compressor 61 and the limiter 64. FIG. 9 provides a graphical representation of this effect. As previously discussed, the compressor applies a compression function shown as the upper curve in FIG. 9. In contrast, the system gamma is applied after the compression applies a function shown by the lower curve. The overall result of the compression and subsequent application of system gamma is shown by the combined curve. As can be seen from FIG. 9, this departs less from a linear slope than the results of compression on its own. Accordingly, values are increased by a smaller amount and the subsequent limiter module therefore needs to provide less of a limiting function. This means less limiting is required thereby providing a closer practical approximation to the desired output.

FIG. 6B shows a further variation which may be applied to the arrangement of FIG. 6 or 6A which introduces a further non-linearity using a non-linear module 69 in each of the RGB channels after the XYZ to linear RGB conversion but prior to the application of an OETF or inverse of display EOTF. This additional non-linearity may be applied to compensate for the Hunt effect.

The post-processor 42, 52 within the path to an HDR display implements an inverse of the process of any of FIGS. 6, 6A and 6B. Accordingly, it is simplest to explain the process by referring to the respect one of these figures and considering these in reverse. A post-processor will therefore receive an RGB signal that looks like Rec 709 format and uses an inverse of the OETF to provide linear RGB. An RGB to XYZ converter is then applied followed by an XYZ to U′V′ converter. An inverse of the limiter function is then applied to the luminance signal Y and then an inverse of the compressor function on the now limited luminance signal. The resulting luminance component which may now be considered a high dynamic range luminance component and the Y, U′ and V′ components are converted back to XYZ. The XYZ signal now having a high dynamic range is converted back to RGB linear signals. Lastly, the linear RGB signals are converted to RGB using an OETF. The output of the post-processor is therefore an HDR signal apparently provided using an HDR OETF. The HDR display then applies the HDR EOTF to provide an appropriate HDR appearance. The choice of EOTF within the HDR display will therefore depend upon whether the system gamma has been applied within the pre-processor as in FIG. 6A or not as in FIG. 6.

The preferred implementation of the pre-processor 40, 50 and post-processor 42,52 described in the embodiments is preferably using a 3D look-up table (3D-LUT). Existing SDR receivers include a 3D-LUT to map the colorimetry of the input signal to that of the native colorimetry of the display, or implement manufacturer selected pre-sets to the choice of “look” such as “vivid”, “film” and so on. Each “look” is designated by settings in the 3D-LUT that take the inputs in 3D RGB space and provide RGB outputs, wherein each of the R, G and B outputs is based on a combination of the RGB inputs (hence the 3D nature of the table). The size of the 3D-LUT will depend upon the number of bits in the signal. A 10 bit signal would require 2¹⁰ lookups and a 30 bit signal 2³⁰ lookups. The latter may be too large and so a design choice would be to use a smaller 3D-LUT and to interpolate between values.

The 3D-LUT already existing within SDR receivers could, therefore, be modified to implement the compression and limiting functions of the pre-processor. If this could be done, then there would be no requirement for a post-processor at HDR receivers. However, this would require transmission of the new 3D-LUT settings to existing SDR receivers and so is not the preferred option. Instead, it is preferred to implement a pre-processor 3D-LUT prior to transmission and to include the post-processor 3D-LUT within new HDR receivers. The post-processor 42, 52 may therefore be considered to be a component within a new HDR display, set-top-box, receiver or other device capable of receiving video signals. The preferred implementation is a simple modification by including appropriate values within an existing 3D-LUT of an HDR display. Such values could be provided at the point of manufacture or later by subsequent upgrade using an over air transmission or other route. The values for such a lookup table would may be calculated according to the calculation for Y_{MAX} described herein including Appendix A and using chosen limiting functions such as those shown in FIG. 7A.

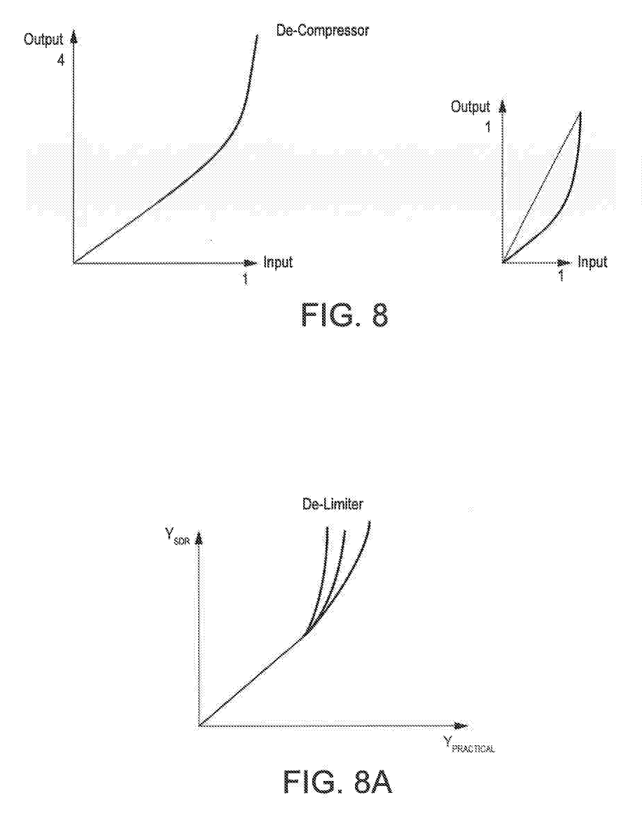

The 3D-LUT or other LUT may implement some or all of the functionality of the pre-processor and post-processor. Some aspects may require calculation for accuracy, other aspects could be performed by lookup. For example, the calculation of maximum luminance level can be pre-calculated and stored in a 2D LUT. However a problem with using multidimensional LUTs is that their memory requirements can get impracticably large depending on the number of bits in the input signal. For example the signal inputs may be floating point (e.g. 16 bit format), in which case a 2D LUT would be impracticably large. So for floating point signal it would be better to implement a module to perform calculations. The same goes for other parts of the functional components of FIGS. 6 to 8. Blocks can be implemented as LUTs, provided the signals are in a fixed point format with sufficiently few bits.

In general, 3D LUTs for video, e.g. changing colour space, use a reduced number of bits on the input to a lookup table and then interpolate to generate results for the full number of input bits. This works well in practice for video. However for intermediate steps of a process (as here) the loss of precision due to interpolation may be significant. We have appreciated, therefore, that it may not be appropriate to use multidimensional LUTs for all functional blocks.

However implemented, the arrangement ensures that the following three conditions are met:

(1) Y_{HDR} is less than or equal to Y_{MAX}
This is because the HDR components are normalised to be in the range [0:1] consequently it is not possible for YHDR to be greater than Ymax.

(2) Y_{SDR} may be greater than Y_{MAX}
This would give hard clipping in the target scheme as at least one of the calculated values of RGB would be greater than 1.0.

(3) Y_{PRACTICAL} must be less than or equal to Y_{MAX}

This is condition enforced by the limiter to avoid the problems discussed.

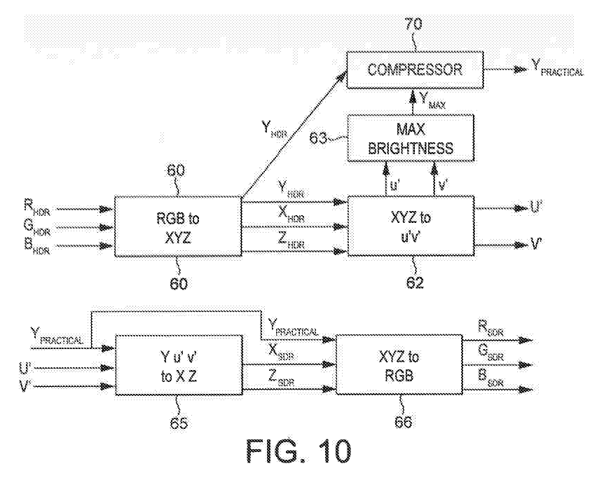

FIG. 10 shows an alternative embodiment using a single compression module that performs the function of the compressor 61 and limiter 64. As previously described an RGB signal is received having high dynamic range (HDR). The signal comprises frames of pixels. A conversion block converts the frames of pixels to a luminance component and separate colour components for each pixel, here in XYZ format. At this stage, the XYZ format remain and HDR signal for which we wish to provide and SDR compatible output. A second conversion block converts the XYZ frames to u′ v′ format (Y remaining as the luminance component as mentioned above). The components u′ v′ represent colour values only with no luminance component and can be considered as different colours on a 2D surface, with the position on that surface being a unique colour. In short, all allowable colours are represented by the two components, with luminance completely separately represented by Y.

The embodiment provides an adjustment to the Y component for each pixel as before using a compressor block. However, the allowable brightness of a given pixel in the target dynamic range is not a fixed value for all colours and so the compressor 70 provides both a compressive and limiting function. The allowable brightness is a function of colour.

The purpose of the maximum brightness block may be appreciated by an exemplar considering particular colours. Consider a pixel having a pure blue colour. This colour may have a maximum allowable luminance value in the target scheme that is lower than, say, a pure red pixel. If one applied the same luminance compression to both colours, one would potentially have the blue colour above an allowable level in the target scheme, and the red in an allowable range. As a result, the blue colour would not be correctly represented (it would have a lower value than intended) and we would have a colour shift: more red in comparison to blue.

The maximum brightness block therefore determines a maximum allowable luminance value for each colour component in relation to the lower dynamic scheme. This is provided as an input to a compression block that applies a compression function to the luminance component of each pixel to produce a compressed luminance component. Significantly, the compression function depends upon the maximum allowable brightness in the lower dynamic range scheme for the corresponding colour component of each pixel. In this way, the effective compression curve used for each colour differs whilst ensuring a maximum RGB value is not violated.

The output comprises an RGB signal that originated from an HDR RGB signal but which is usable within SDR systems. Moreover, the reverse process may be operated to recover an HDR RGB signal by splitting into components as before and operating a reverse of the compression curves.

One might think that quantisation problems could result in consequence of alterations to the luminance components using the compression limiting and subsequent delimiting and decompression functions. However, it is noted that grey pixels remain unaltered by the process and significant changes only occur to highly coloured pixels. The human eye is less sensitive to quantisation of colour than luminance and so it is unlikely to be a problem. In any event, precision of the compressor and limiter can be chosen to be sufficient such that these do not inherently limit the quantisation and this is a further reason why quantisation problems should not arise.

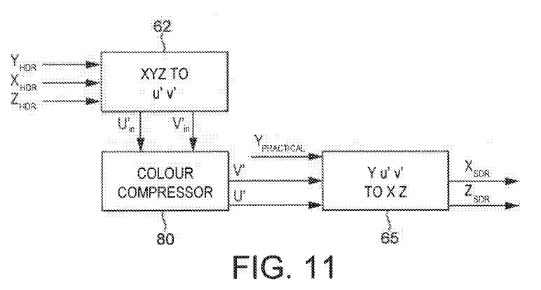

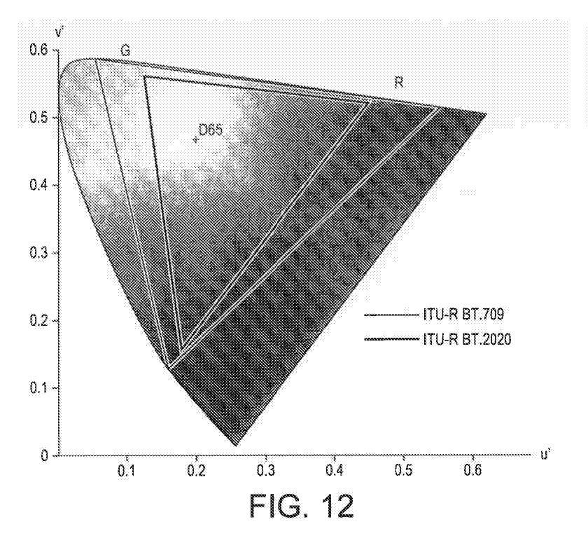

We have appreciated a further advantage than may be provided in any of the embodiments of the invention by applying a further variation to those embodiments that implements colour compression. Separately from considerations of the dynamic range, it is preferred that modern displays and systems generally should use a wider colour gamut than previous systems. Accordingly, it is desired that a signal acquired using such a wider colour gamut such as Rec 2020 should be viewable on an existing display designed for Rec 709. For this purpose, an additional colour compressor may be provided within the pre-processor and post-processor as shown in FIGS. 11 and 12.

FIG. 11 shows the position of the colour compressor 80 within the functional modules of a pre-processor or post-processor. The example here is in the pre-processor component sequence inserted between the XYZ to UV converter and the YUV to XZ converter. At this point in the process, the signals UV are available which represent colour space without luminance. The colour compressor 80 applies a compression to the colour components to bring those components from a wider gamut Rec 2020 to a narrower gamut Rec 709 as conceptually shown in FIG. 12. FIG. 12 (in monochrome) a representation of all colours with red, green and blue shown as vertices in the UV space. The wider gamut of Rec 2020 is represented by the outer triangle and the narrower gamut of Rec 709 by the inner triangle. On any particular line from the centre point shown by D65 which represents pure white, a line radially outward from that point represents a single colour of increasing in saturation. To bring values from the wider gamut to the narrower gamut a compression function may be used so that, without loss of any information, colours acquired using the wider gamut may be represented appropriately on a narrower gamut display.

The choice of compression function applied to the radial colour components of FIG. 12 may be any of the compression functions previously described, but particularly advantageously may be the “Knee” function. This provides minimum alteration to less saturated colours and a gradual change to the more saturated colours. Within a post-processor, a colour decompressor implements the inverse of the compression function to return the full colour gamut without any loss of information. Such an additional function may be used with any of the embodiments previously described and the colour compressor may be applied using a look up table or indeed may be included in the single 3D-LUT of the whole pre-processor or post-processor.

As previously noted, the invention may be implemented using separate functional components as described in relation to FIGS. 6, 6A and 6B operable as the pre-converter or post converter. Alternatively, the invention may be implemented using a 3D-LUT on the transmitter side or receiver side, in which case the values of such a 3D-LUT would be populated according to calculation of Y_{MAX} and chosen limiting functions.

### APPENDIX A

### Determining the Maximum Luminance for a Given Colour

This appendix addresses how to determine the maximum value of luminance (CIE 1931 Y) given a colour defined by u′/v′ colour co-ordinates. Let this maximum luminance value be denoted Yₘₐₓ.

If we knew the colour coordinates XYₘₐₓZ (CIE 1931) then, when we calculated the corresponding RGB co-ordinates, in the output colour space, we would find that one or more of RGB would be 1.0, since this is the maximum permitted value for RGB components. To find Yₘₐₓ we would to find algebraic formulae for the values of RGB, given XYₘₐₓZ, and then solve these to find Yₘₐₓ. However, we have co-ordinates Yₘₐₓu′v′, so we need to find formulae for RGB in terms of Yₘₐₓu′v′, then we can solve for Yₘₐₓ.

Given the values of Yₘₐₓu′v′ the corresponding values of X & Z are given by

$$X = Y \cdot \frac{9 {u}^{′}}{4 {v}^{′}} \\ Z = \frac{12 - 3 {u}^{′} - 20 {v}^{′}}{4 {v}^{′}} \qquad Equation 1$$

Given XYZ components, then RGB components are calculated by pre-multiplying by a 3×3 matrix (as is well known), where the matrix, denoted “M” herein, depends on the RGB colour space. So,

$$[ \begin{matrix}R \\ G \\ B\end{matrix} ] = [ \begin{matrix}{m}_{11} & {m}_{12} & {m}_{13} \\ {m}_{21} & {m}_{22} & {m}_{23} \\ {m}_{31} & {m}_{32} & {m}_{33}\end{matrix} ] \cdot [ \begin{matrix}X \\ Y \\ Z\end{matrix} ] \qquad Equation 2$$

Substituting equation(s) 1 into equation 2 yields:

$$R = Y ( {m}_{11} \frac{9 {u}^{′}}{4 {v}^{′}} + {m}_{12} + {m}_{13} \frac{12 - 3 {u}^{′} - 20 {v}^{′}}{4 {v}^{′}} ) \\ G = Y ( {m}_{21} \frac{9 {u}^{′}}{4 {v}^{′}} + {m}_{22} + {m}_{33} \frac{12 - 3 {u}^{′} - 20 {v}^{′}}{4 {v}^{′}} ) \\ B = Y ( {m}_{31} \frac{9 {u}^{′}}{4 {v}^{′}} + {m}_{32} + {m}_{33} \frac{12 - 3 {u}^{′} - 20 {v}^{′}}{4 {v}^{′}} ) \qquad Equation 3$$

We may re-write this as:

$$R = \frac{Y}{4 {v}^{′}} ( {k}_{11} {u}^{′} + {k}_{12} {v}^{′} + {k}_{13} ) \\ G = \frac{Y}{4 {v}^{′}} ( {k}_{21} {u}^{′} + {k}_{22} {v}^{′} + {k}_{23} ) \\ B = \frac{Y}{4 {v}^{′}} ( {k}_{31} {u}^{′} + {k}_{32} {v}^{′} + {k}_{33} ) \qquad Equation 4$$

where the values of the matrix K are defined as:

$$K = [ \begin{matrix}{k}_{11} & {k}_{12} & {k}_{13} \\ {k}_{21} & {k}_{22} & {k}_{23} \\ {k}_{31} & {k}_{32} & {k}_{33}\end{matrix} ] = [ \begin{matrix}( 9 {m}_{11} - 3 {m}_{13} ) & ( 4 {m}_{12} - 20 {m}_{13} ) & 12 {m}_{13} \\ ( 9 {m}_{21} - 3 {m}_{23} ) & ( 4 {m}_{22} - 20 {m}_{23} ) & 12 {m}_{23} \\ ( 9 {m}_{31} - 3 {m}_{33} ) & ( 4 {m}_{32} - 20 {m}_{33} ) & 12 {m}_{33}\end{matrix} ] \qquad Equation 5$$

Now, as stated above, for maximum luminance, Yₘₐₓ, at least one of RGB must be 1.0. therefore, from equation(s) 4 one or more of the following must be true:

$${Y}_{max} = \frac{4 {v}^{′}}{( {k}_{11} {u}^{′} + {k}_{12} {v}^{′} + {k}_{13} )} \\ {Y}_{max} = \frac{4 {v}^{′}}{( {k}_{21} {u}^{′} + {k}_{22} {v}^{′} + {k}_{23} )} \\ {Y}_{max} = \frac{4 {v}^{′}}{( {k}_{31} {u}^{′} + {k}_{32} {v}^{′} + {k}_{33} )} \qquad Equation 6$$

where the 3 equations are derived from the maximum values of R, G & B equal to 1.0.

Hence the maximum luminance, Yₘₐₓ, is the minimum of the values calculated from equation(s) 6.

For example, with and ITU Recommendation BT.709 colour space the matrix M, to convert from XYZ to RGB may be calculated, from the specification, to be:

$$[ \begin{matrix}R \\ G \\ B\end{matrix} ] = [ \begin{matrix}3.240969942 & - 1.537383178 & - 0.49861076 \\ - 0.969243636 & 1.875967502 & 0.041555057 \\ 0.05563008 & - 0.203976959 & 1.056971514 \end{matrix} ] \cdot [ \begin{matrix}X \\ Y \\ Z\end{matrix} ] \qquad Equation 7$$

From this we may calculate the matrix, K, to be:

$$K = [ \begin{matrix}30.66456176 & 3.822682496 & - 5.983329124 \\ - 8.847857899 & 6.672768858 & 0.498660689 \\ - 2.670243825 & - 21.95533812 & 12.68365817 \end{matrix} ] \qquad Equation 8$$

1. A method of processing a video signal from a higher dynamic range source having a source colour scheme to produce a signal usable by target devices of a lower dynamic range and having a target colour scheme, comprising receiving the video signal from the source, the video signal comprising pixels, and converting using a converter that implements the following or an equivalent function:
providing the received signal as a luminance component and separate colour components for each pixel;
determining a maximum allowable luminance value for the colour components when provided in the lower dynamic range scheme;
applying a compression function to the luminance component of each pixel to produce a compressed luminance component; and
providing the compressed luminance component and separate colour components to provide an output signal in the target colour scheme;
wherein the compression function depends upon the maximum allowable luminance value for the corresponding colour components of each pixel.

2. A method according to claim 1, wherein the compression function for each colour has a maximum output equal to the maximum luminance value for the colour components when provided in the lower dynamic range scheme.

3. A method according to claim 2, wherein the compression function conceptually provides a set of compression curves with a curve for each colour.

4. A method according to claim 1, wherein the compression function comprises a compression aspect and separate limiting aspect.

5. A method according to claim 4, wherein the compression aspect applies the same compression curve to all luminance values.

6. A method according to claim 4, wherein the limiting aspect applies a limiting function that varies according to the maximum allowable luminance value for the colour components when provided in the lower dynamic range scheme.

7. A method according to claim, 1 wherein the step of providing the received signal as a luminance component and separate colour components includes applying an inverse of an OETF applied at the source.

8. A method according to claim 1, wherein the step of providing the compressed luminance component and separate colour components in the target colour scheme to provide the output signal includes applying an OETF appropriate for the target devices of lower dynamic range.

9. A method according to claim 1, wherein the converter further implements applying a system gamma and the step of providing the compressed luminance component and separate colour components in the target colour scheme to provide an output signal includes applying an inverse of an EOTF of the target devices of lower dynamic range.

10. A method according to claim 1, wherein the video signal from the source is in RGB or YCbCr format and providing the received signal as a luminance component and separate colour components for each pixel comprises conversion from that format.

11. A method according to claim 1, wherein the providing the compressed luminance component and separate colour components in the target colour scheme as an output signal comprises conversion to RGB or YCbCr.

12. A method according to claim 11, further comprising applying a non-linearity in each of the channels.

13. A method according to claim 11, wherein the conversion to RGB or YCbCr includes providing the output substantially according to Rec 709.

14. A method according to claim 1 wherein the source colour scheme and target colour scheme are the same.

15. A method according to claim 1, wherein the wherein the source colour scheme has a wider gamut that the target colour scheme.

16. A method according to claim 15, wherein the converter further implements compression of the colour components from source colour scheme to the target colour scheme.

17. A method of processing an output signal usable by a display of lower dynamic range having a target colour scheme to provide a signal for a display of higher dynamic range, comprising applying an inverse conversion using an inverse converter that implements the following or an equivalent function:
providing compressed luminance component and separate colour components obtained from the output signal;
applying a de-compression function to the compressed luminance component of each pixel to produce a luminance component;
providing the luminance component and separate colour components for each pixel in the higher dynamic range colour scheme;
wherein the de-compression function depends upon the maximum allowable luminance value for the corresponding colour components of each pixel in the target colour scheme.

18. A method according to claim 17, wherein the de-compression is the inverse of a compression applied to the output signal.

19. A method according to claim 17, wherein the de-compression comprises a de-compression aspect and de-limiting aspect.

20. A method according to claim 17, wherein the converter or de-converter comprises separate modules for each of the steps.

21. A method according to claim 17, wherein the wherein the converter or de-converter comprises a 3D-LUT having values to provide the conversion.

22. A converter for converting a video signal from a higher dynamic range source having a source colour scheme to produce a signal usable by target devices of a lower dynamic range and having a target colour scheme, comprising receiving the video signal from the source, the video signal comprising pixels and converting using a converter that comprises:
means for providing the received signal as a luminance component and separate colour components for each pixel;
means for determining a maximum allowable luminance value for the colour components when provided in the lower dynamic range scheme;
means for applying a compression function to the luminance component of each pixel to produce a compressed luminance component; and
means for providing the compressed luminance component and separate colour components to provide an output signal in the target colour scheme;
wherein the compression function depends upon the maximum allowable luminance value for the corresponding colour components of each pixel.

23. A converter for converting an output signal usable by a display of lower dynamic range to provide a signal for a display of higher dynamicrange, the converter comprising:
means for providing compressed luminance component and separate colour components obtained from the output signal;
means for applying a de-compression function to the compressed luminance component of each pixel to produce a luminance component;
means for providing the luminance component and separate colour components for each pixel in the higher dynamic range colour scheme;
wherein the de-compression function depends upon the maximum allowable luminance value for the corresponding colour components of each pixel in the target colour scheme.

24. A converter according to claim 22, wherein the converter comprises a 3D-LUT.

25. A method of processing a video signal from a higher dynamic range source having a source colour scheme to produce a signal usable by target devices of a lower dynamic range and having a target colour scheme, or the inverse, comprising receiving the video signal from the source, the video signal comprising pixels and converting using a converter comprises a 3D lookup table whose values are derived by:
determining a maximum allowable luminance value for colour components in a format comprising luminance and separate colour components when provided in the lower dynamic range scheme;
selecting a compression function for the luminance component of each pixel to produce a compressed luminance component wherein the compression function depends upon the maximum allowable luminance value for the corresponding colour component of each pixel for the target colour scheme; and
providing the 3D lookup table values according to the maximum allowable luminance values and selected compression function.

26. A converter for processing a video signal from a higher dynamic range source having a source colour scheme to produce a signal usable by target devices of a lower dynamic range and having a target colour scheme, or the inverse, comprising means for receiving the video signal from the source, the video signal comprising pixels and wherein the converter comprises a 3D lookup table whose values are derived by:
determining a maximum allowable luminance value for colour components in a format comprising luminance and separate colour components when provided in the lower dynamic range scheme;
selecting a compression function for the luminance component of each pixel to produce a compressed luminance component wherein the compression function depends upon the maximum allowable luminance value for the corresponding colour component of each pixel for the target colour scheme; and
providing the 3D lookup table values according to the maximum allowable luminance values and selected compression function.

27. (canceled)

28. (canceled)

29. (canceled)

30. (canceled)

31. (canceled)

32. (canceled)

33. (canceled)

34. (canceled)
